(19) United States
(12) Patent Application Publication
(10) Pub. No.: US 2005/0038632 A1
(43) Pub. Date: Feb. 17, 2005

(54) Method for diagnosing operating faults of an assembly of electronic systems, in particular in a motor vehicle

(76) Inventors: Samuel Boutin, Magny les Hameaux (FR); Ray Snyder, Paris (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/497,856

(22) PCT Filed: Dec. 6, 2002
(86) PCT No.: PCT/FR02/04207

(30) Foreign Application Priority Data
Dec. 7, 2001 (FR) 01/15819

(51) Int. Cl. G06F 11/30

(52) U.S. Cl. 702/183

(57) ABSTRACT

The invention concerns a method which consists in: a) when launching a diagnostic phase, in selecting the data (Xi) which have a specific value (Xip), b) for each selected data (Xi), finding the group (X8i) of data from which said specific value (Xip) taken by the data (Xi) is likely to originate, c) creating a list (X8) of data contained in the intersection of said groups (X8i) of data, and d) analyzing said list (X8) to identify the element(s) of the set whereof an operating fault from which said specific values taken by said data (Xi) originate.

The present invention relates to a method for diagnosis of operating faults of an assembly of integrated electronic systems receiving and producing multiplexed data, at least one of the said data being capable of assuming a predetermined particular value following the occurrence of an operating fault of at least one of the components of the said systems.

Assemblies of electronic systems of this type, designed in particular as equipment for motor vehicles, are known. Such a vehicle is commonly provided with a plurality of systems, each assuring the execution of a service, such as control of the engine that powers the vehicle, management of the air conditioning of the passenger compartment, management of the interactions of the vehicle with the ground (braking, suspension, . . . ), management of telephone communications, etc., etc.

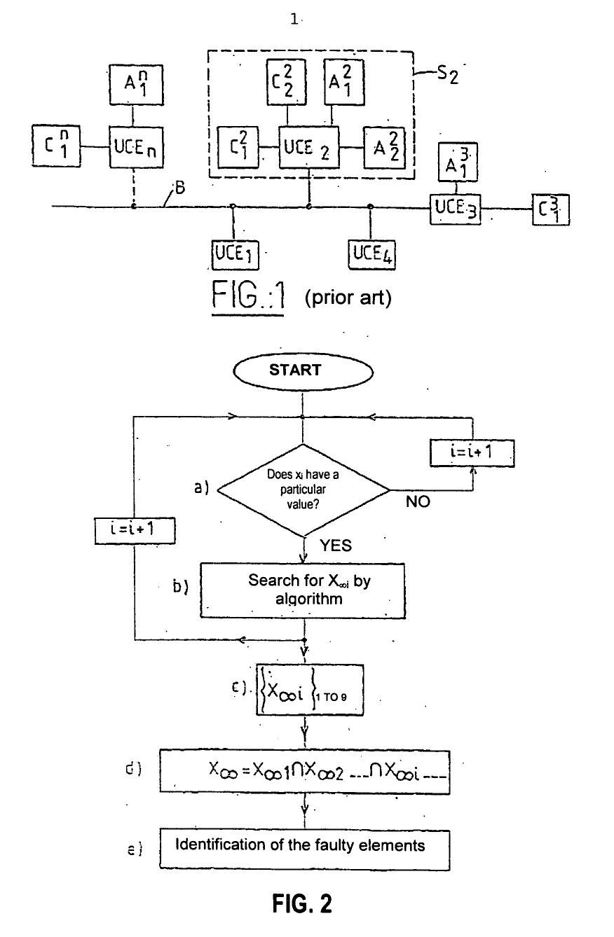

FIG. 1 of the attached drawing schematically shows the physical components of the assembly of these systems. These components substantially comprise “calculators” or electronic control units UCEₘ, each electronic control unit being connected if necessary to sensors Cⁿᵢ and to actors A^{m}ⱼ, all electronic control units being connected to at least one and the same bus B, to transmit thereto or receive therefrom information, which may be multiplexed, for example, originating from or destined for other electronic control units connected to bus B.

Such multiplexing is achieved in particular, as is well known for the CAN bus, for example, by introducing the information in question into messages having the form of digital signal frames.

As an illustrative example, “engine control” system S₂ comprises electronic control unit UCE₂, a plurality of sensors C²ᵢ that are sensitive to variables such as the engine speed, for example in the case of an internal-combustion engine, the pressure in the intake manifold of this engine, the outside air pressure, the temperature of the engine cooling water, the air temperature, the charge condition of the battery, etc., etc., and a plurality of actors A²ⱼ. Electronic control unit UCE₂ is duly programmed to execute a plurality of engine-control functions, such as: regulation of idling speed, regulation of richness of the air/fuel mixture, control of the ignition advance of this mixture, and recirculation of the exhaust gases. To achieve this, electronic control unit UCE₂ utilizes the information arriving from the aforesaid sensors C²ᵢ and processes control signals for the actors A²ⱼ, which are composed of an additional air-control valve and a spark-plug coil for the “idling-speed regulation” function, of a fuel injector for the “richness regulation” function, of the same ignition coil for the “ignition advance” function and of a valve for the “exhaust-gas recirculation” function.

The other “services” cited hereinabove, “air conditioning of the passenger compartment”, “interaction with the ground”, etc., are executed by systems whose architecture is analogous to that described in the foregoing for engine control.

All these systems, which communicate via the same bus B, comprise a multiplexed network. It is then conceivable that a plurality of functions based on different systems can utilize information originating from the same sensors, for example, thus avoiding costly redundancies in the structure of the assembly of systems. The use of a multiplexed network also permits the length of the electric lines interconnecting the different elements of the assembly to be greatly shortened. Furthermore, it is possible with such a multiplexed assembly to achieve functions that are non-traditional and that may be complex, sometimes involving a plurality of systems and for this reason being known as “cross-functional”. As an illustrative and non-limitative example, the perception of “airbag deployed” information, suggesting that the vehicle has suffered a collision, may then be processed in such a way as to command that an emergency call be transmitted by a mobile telephony device installed on board the vehicle.

From French Patent Application No. 00-08251, filed 27 Jun. 2000 by the Applicant, there is known a method for evaluating the operating reliability of such an assembly of integrated systems that receive and produce data. With this method it is possible to evaluate the impact of any modification made to the system during its design phase, and therefore to be certain that this modification does not significantly alter the operating reliability of the assembly, as is particularly necessary in the motor-vehicle environment, in order to assure the safety of the passengers.

During the useful life of the vehicle, it sometimes happens that certain of the components of the assembly (sensors, actors, electronic control unit, bus, etc.) break down or are subject to faulty operation, and it is therefore desirable to have means for diagnosing these breakdowns or operating faults. It would be advantageous for these means to be designed in such a way as to make it possible, throughout the vehicle design phase, to verify that the changes made to the electronic systems installed on board the vehicle during this phase do not alter the diagnostic capacity of these means.

The object of the present invention is precisely to provide a method for diagnosis of operating defects that affect an assembly of electronic systems of the type described hereinabove, or in other words an assembly in which systems produce and exchange multiplexed data.

Another object of the present invention is to provide such a method whose diagnostic capacity can be evaluated at any time during the design phase of a motor vehicle equipped with such an assembly of multiplexed systems.

These objects of the invention, as well as others that will become apparent upon reading the description to follow, are achieved with a method for diagnosis of operating faults of an assembly of electronic systems producing and consuming data, at least one of the said data (xᵢ) being capable of assuming a predetermined particular value (xᵢₚ) following the occurrence of an operating fault of at least one of the components of the said assembly, this method comprising the following stages:
a) when a diagnostic phase is initiated, the data (xᵢ) having a particular value (xᵢₚ) are selected,
b) for each datum (xᵢ) selected in this way, a search is performed for the group (X_{∞i}) of data capable of being responsible for the particular value (xᵢₚ) assumed by the datum (xᵢ),
c) the list (X_{∞}) of data belonging to the intersection of the said groups (X_{∞i}) of data is established, and
d) the said list (X_{∞}) is analyzed to identify the component or components of the assembly in which an operating fault is responsible for the particular values (xᵢₚ) assumed by the said data (xᵢ).

As will be seen in detail hereinafter, this method makes it possible, by virtue of a data-processing algorithm capable of inferring the causes of operating faults from the observed effects of these faults, to identify the elements or devices affected by the faults, and in turn to remedy them:

According to other characteristics of the present invention, there are excluded from the list (X_{∞}), in stage c) or d), the data that do not correspond to the observed effects of operating faults, and/or the data transmitted by at least one predetermined system component whose reliability is not in doubt, such as an electronic control unit or a bus, for example.

Other characteristics and advantages of the present invention will become apparent upon reading the description hereinafter and upon examining the attached drawing, wherein:

FIG. 1 is a block diagram of an assembly of electronic systems wherein it is proposed that means for diagnosis of operating faults according to the present invention be provided, this assembly being described in the introduction of the present description, and

FIG. 2 is a flow diagram of the diagnostic method according to the invention.

This is used by setting up a database containing all the information with which the physical, functional and operational architecture of the assembly of electronic systems can be described.

In a manner analogous to that described in the aforesaid French Patent Application No. 00-08251, there also is compiled a software tool appropriate for interrogating the database by means of queries, in such a way as to execute the algorithms that search for causes of operating faults described hereinafter. By way of illustrative and non-limitative example, it will be possible to use SQL (structured query language) for this purpose, as is familiar to the person skilled in the art.

If x is an object of the database, a query on x is noted in the sequence F(x). The upper-case notation X is used to denote a given set. F(X) is then the union of sets F(x) for x belonging to X. This is coherent with the utilization of the queries of a database, since the result of a query is a set of solutions. Since the results of a plurality of queries on homogeneous elements are homogeneous, it is possible to speak of their union or reunion.

According to the invention, after initiation of a phase of diagnosis of operating faults, there is selected (stage a of the flow diagram of FIG. 2) in this base each datum xᵢ (i from 1 to q) that assumed a particular value xᵢₚ following the event that constitutes the occurrence of an operating fault of one or more components of the assembly of electronic systems under consideration: sensor or actor, electronic control unit, bus, etc.

Thus a datum xᵢ can assume a predetermined particular value xᵢₚ indicative of the fact that the datum has become invalid or erroneous, or of the fact that an electronic control unit, a bus, a sensor or an actor has broken down or its operation has become degraded, or else of the fact that a digital signal frame containing the datum is invalid or absent, etc., etc.

Once each datum xᵢ associated with a particular value xᵢₚ has been selected in this way, the stage (b) according to the invention is to backtrack to the set of data capable of being responsible for the association with a particular value xᵢₚ with xᵢ, and from there to the primary causes of this circumstance, such as, by way merely of illustrative and non-limitative example, operating faults of the types cited hereinabove.

Considering a datum xᵢ associated with a particular value xᵢₚ produced or consumed by one or more functions of the assembly of electronic systems under consideration, there is noted:
F(xᵢ), the query for “set of functions that have xᵢ as output datum, and that can associate the particular value xᵢₚ with xᵢ producing it at the output”,
G(f, {xⱼₚ}), the query for “set of data representative of “feared” events for the function f, or in other words those events for which the function becomes faulty and are such that f produces the datum xⱼ associated with the particular value xⱼₚ at the output (the function f being able to have several “degraded” modes or operation),

$$G ( f , X ) = \begin{matrix}⋃ \\ xeX\end{matrix} G ( f , \{ x \} )$$

It is then possible to write:
X₁={xᵢₚ}∪G(F({xᵢₚ}), {xᵢₚ})=Xₒ∪G(F(Xₒ), Xₒ)
by setting Xₒ={xᵢₚ},
X₁ being the set of data representative of events that could have caused the transmission of the datum xᵢ=xᵢₚ.

In the same way there is defined:
X₂=X₁∪G(F(X₁), X₁)
as the set X₂ of data that could have produced xᵢ after all functions producing xᵢ have been applied at least two times.

From the foregoing there is deduced the recurrent sequence of sets of data (Xₒ, . . . Xₙ, Xₙ₊₁, . . . ) such that:
Xₒ={xᵢ} and
Xₙ₊₁=Xₙ∪G(F(Xₙ), Xₙ)

X_{∞i} is defined as the limit of the sequence Xₙ as n tends to +∞, in which case X_{∞i} designates the set or group of data representative of events that could have caused transmission of xᵢ=xᵢₚ.

It is obviously necessary to be sure of the existence of X_{∞} and of the fact that the found set G(F(X_{∞}), X_{∞}) of events is an actual subset of X_{∞}.

Regarding the first point, it is clear that Xₙ⊂Xₙ₊₁. Furthermore, since Xₙ is included in the set of events of the assembly of electronic systems, there exists an index N for which X_{N+1}=X_{N}.

It follows that:
X_{N+2}=X_{N+1}∪G(F(X_{N+1}), X_{N+1})=X_{N}∪G(F(X_{N}), X_{N})=X_{N+1}=X_{N}

As a result, by recurrence, X_{∞}=X_{N}, which demonstrates the existence of X_{∞}.

On the second point, since X_{N+1}=X_{N}∪G(F(X_{N}), X_{N}), it is inferred, by replacing X_{N+1} and X_{N} by X_{∞}, that:
X_{∞}=X_{∞}∪G(F(X_{∞}), X_{∞})

Reading this equality from right to left makes it apparent that every element of G(F(X_{∞}), X_{∞}) belongs to X_{∞}and therefore that G(F(X_{∞}), X_{∞}) is an actual subset of X_{∞}.

The algorithm described in the foregoing is repeated for all the data xᵢ such that xᵢ=xᵢₚ (stage c), thus producing q groups X_{∞i} (i from 1 to q) of data.

According to the invention, the list X_{∞} of data xᵢ=xᵢₚ that belong to the intersection of these two groups (stage d) is then established, or in other words:
X_{∞}=X_{∞1}∩X_{∞2} . . . ∩X_{∞1 . . .}
and the components that transmitted these data are reviewed, in order to identify the component or components of the assembly of electronic systems (sensors, actors, electronic control units, bus, etc.) that may be affected by an operating fault (stage e).

The faults affecting these components can affect the inputs or the outputs of the functions executed in the assembly of electronic systems. The output faults are particular values of “network” data: an erroneous datum (whose fault has not been diagnosed), a datum indicated to be faulty, a datum having a particular value, or particular values of “telecommunication” data delivered by sensors or actors, for example: erroneous datum, or datum indicated to be faulty.

The input faults of functions are, in addition to the faults cited hereinabove: the absence of an electronic control unit, of a frame or of a bus, the failure of an actor or of a sensor, or even internal faults of an electronic control unit (in “reset”, CRC error, supply-voltage or grounding error, ECU mute, etc . . . ).

The number of data contained in intersection X_{∞} of data sets X_{∞i} may be large. However, only those sets of those data that are representative of faults of components of the assembly of electronic systems (sensors, actors, connectors, telecommunications, electronic control units, etc.) need be used.

In addition, the vehicle driver may observe that functional devices installed on board the vehicle are operating properly or in certain cases are not operating or are operating in degraded manner (such as a breakdown of the air-conditioning system, for example).

Similarly, a mechanic commissioned to repair the vehicle in breakdown condition may identify the causes of possible breakdowns by virtue of the diagnostic data transmitted over the bus.

All of these observations make it possible to distinguish, within the intersection X_{∞} of data groups X_{∞i}, the data that are consistent with the observations made, thus making it possible to rule out the others in the course of the search for the cause of breakdowns.

Similarly, even if the reasonable hypothesis is made that the origin of a breakdown being sought does not lie in an electronic control unit or a bus, because of the fact of the high reliability of these completely electronic devices, it will still be possible to extract from X_{∞} all the data that originated in these devices.

According to the invention, therefore, it is very easily possible in this way to locate a sensor or an actor responsible for an operating fault observed by the driver or the mechanic, even when the correlation between the observed breakdown and the cause of the breakdown is far from being evident.

As an illustrative and non-limitative example of such a situation, there can be cited the case in which a driver observes a breakdown of the air-conditioning system in a vehicle in which deactivation of this system has been programmed if the fuel level contained in the vehicle tank falls below a low level, for the purpose of reducing the vehicle consumption until it is possible to refill the tank.

A search for the cause of this breakdown conducted via the algorithmic method according to the invention may reveal that the cause of this breakdown results from an operating fault of a sensor designed to measure the fuel level in the fuel tank.

It will be noted that the method for diagnosis of faults according to the present invention may be used not only during the design phase of a vehicle equipped with multiplexed electronic systems, but also after the vehicle has been placed in service. In accordance with one of the objects pursued by the present invention, it is possible in this way to verify that the changes undergone by these systems during this design phase do not alter the capacities according to the invention for diagnosis of faults of on-board systems.

Of course, the invention is not limited to the diagnosis of faults affecting an assembly of electronic systems installed on board a motor vehicle. To the contrary, it can be applied in any assembly of electronic systems receiving and producing data that are accessible over a bus.

1. A method for diagnosis of operating faults of an assembly of electronic systems provided with components (Aⁿᵢ; Cⁿᵢ; UCEₙ; B), producing and consuming data, at least one of the said data (xᵢ) being capable of assuming a predetermined particular value (xᵢₚ) following the occurrence of an operating fault of at least one of the components (Aⁿᵢ; Cⁿᵢ; UCEₙ; B) of the said assembly, this method being characterized by the following stages:
a) when a diagnostic phase is initiated, the data (xᵢ) having a particular value (xᵢₚ) are selected,
b) for each datum (xᵢ) selected in this way, a search is performed for the group (X_{∞i}) of data capable of being responsible for the particular value (xᵢₚ) assumed by the datum (xᵢ),
c) the list (X_{∞}) of data contained in the intersection of the said groups (X_{∞i}) of data is established, and

2. A method according to claim 1, characterized in that it comprises the following stage
d) the said list (X_{∞}) is analyzed to identify the component or components of the assembly in which an operating fault is responsible for the particular values (xᵢₚ) assumed by the said data (xᵢ).

3. A method according to claim 1, characterized in that there are excluded from the list (X_{∞}), in stage c) or d), the data that do not correspond to the observed effects of operating faults.

4. A method according to any one of claims 1 and 2, characterized in that there are excluded from the list (X_{∞}), in stage c) or d), the data transmitted by at least one predetermined system component of the assembly.

5. A method according to claim 3, characterized in that the said predetermined component is an electronic control unit (UCEᵢ) or a bus (B).

6. A method according to any one of the preceding claims 1 to 4, applied to an assembly of electronic systems installed on board a motor vehicle.
